(19) United States
(12) Patent Application Publication
(10) Pub. No.: US 2025/0317370 A1
(43) Pub. Date: Oct. 9, 2025

(54) MODEL STACKING FOR SUPPORT TICKET CATEGORIZATION

(71) Applicant: SAP SE, Walldorf (DE)

(72) Inventors: Suketu Dave, Bangalore (IN); Nibedita Dutta, Gurgaon (IN); Sudhir Verma, Gurgaon (IN)

(21) Appl. No.: 18/626,702

(22) Filed: Apr. 4, 2024

(51) Int. Cl. H04L 41/5074; G06N 20/00

(52) U.S. Cl. CPC H04L 41/5074; G06N 20/00

(57) ABSTRACT

Example methods and systems are directed to categorizing support tickets for more efficient handling by support staff. Support staff may be divided into multiple support groups. An incoming support ticket is converted to a machine representation and provided as input to one or more trained machine learning models. Based on the output from the one or more trained machine learning models, the support ticket is routed to one of the support groups. As a result, some tickets will be directly routed to higher-level support groups instead of having all tickets first be evaluated by L1 support personnel. Accordingly, support staff resources are conserved. A model stacking technique may be used in which models of varying complexities, ranging from very simple to highly complex, are stacked in sequence one after another.

### TECHNICAL FIELD

The subject matter disclosed herein generally relates to systems for categorizing support tickets and, more specifically, to systems utilizing model stacking to categorize support tickets.

### BACKGROUND

When a user of a network-based software application encounters a problem with the software application, the user may open a support ticket with the provider of the software application. The provider may use multiple levels of support to handle support tickets from users.

A primary support team (L1 support) is able to handle issues that can be solved by existing solutions. For some solutions, a member of the primary support team talks with the user to help the user solve the issue. For example, a knowledge base article (KBA) may contain information for fixing user settings and customizations. In other solutions, an existing software patch (also referred to as a “note”) is provided by the primary support team to the user. The patch is installed to correct the issue.

A secondary support team (L2 support) is able to handle more issues than the primary support team, such as those that are technically complex, involve the creation of new KBAs, involve the creation of new notes, or any suitable combination thereof. Incoming support tickets may be assigned first to the primary support team, with only the support tickets that the primary support team is unable to resolve being reassigned to the secondary support team.

### BRIEF DESCRIPTION OF THE DRAWINGS

FIG. 1 shows a network diagram illustrating an example network environment suitable for model stacking for support ticket categorization.

FIG. 2 shows a block diagram of a support server, suitable for model stacking for support ticket categorization.

FIG. 3 is a block diagram of a neural network, suitable for use as a model in a model stack for support ticket categorization, according to some example embodiments.

FIG. 4 shows an illustration of an example database schema, suitable for training models suitable for use in a model stack for support ticket categorization.

FIG. 5 shows an illustration of an example database schema, suitable for use in addressing support tickets.

FIG. 6 shows a flowchart illustrating a method of handling support tickets without using model stacking for support ticket categorization.

FIG. 7 shows a flowchart illustrating a method of handling support tickets using model stacking for support ticket categorization.

FIG. 8 shows a flowchart illustrating a method of generating models suitable for use in a model stack for support ticket categorization.

FIG. 9 shows a flowchart illustrating a method of handling support tickets using model stacking for support ticket categorization.

FIG. 10 shows a flowchart illustrating a method of handling support tickets using model stacking for support ticket categorization.

FIG. 11 shows an illustration of an example user interface for assigning support tickets to support groups.

FIG. 12 shows a block diagram showing one example of a software architecture for a computing device.

FIG. 13 shows a block diagram of a machine in the example form of a computer system within which instructions may be executed for causing the machine to perform any one or more of the methodologies discussed herein.

### DETAILED DESCRIPTION

Example methods and systems are directed to categorizing support tickets for more efficient handling by support staff. Support staff may be divided into multiple support groups. For example, an L1 support group may be trained to assist users in finding existing solutions to known problems. An L2 support group may be trained to research new problems and identify new solutions that can be implemented by users. An L3 support group may be enabled to modify a software application to provide a new solution. In various example embodiments, more or fewer support groups are used.

An incoming support ticket is converted to a machine representation and provided as input to one or more trained machine learning models. Based on the output from the one or more trained machine learning models, the support ticket is routed to one of the support groups. As a result, some tickets will be directly routed to higher-level support groups instead of having all tickets first be evaluated by L1 support personnel. Accordingly, support staff resources are conserved.

A model stacking technique may be used in which models of varying complexities, ranging from very simple to highly complex, are stacked in sequence one after another. Simpler models may consume fewer computing resources, but only be able to generate a clear answer for a subset of possible inputs. More complex models may be able to generate a clear answer for a larger range of possible inputs but consume more computing resources.

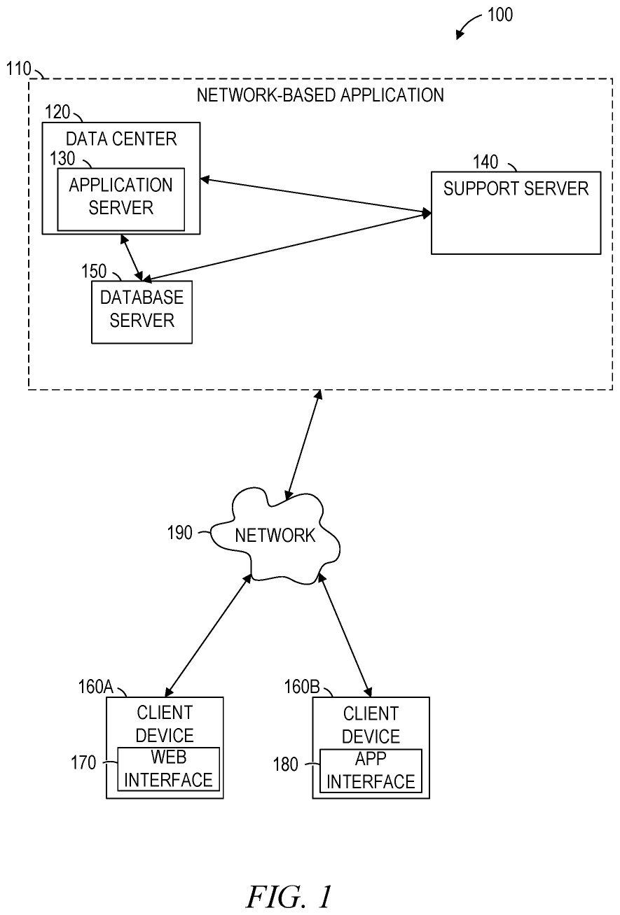

FIG. 1 shows a network diagram illustrating an example network environment 100 suitable for model stacking for support ticket categorization. The network environment 100 includes the network-based application 110, client devices 160A and 160B, and a network 190. The network-based application 110 is implemented at a data center 120 comprising an application server 130 in communication with a support server 140. An application executing on the application server 130 may access data from a database server 150. The support server 140, the database server 150, or any suitable combination thereof, may be part of the data center 120.

Users of the application provided by the application server 130 may raise support tickets when problems with the application are encountered. The support server 140 may access known solutions to problems from a knowledge base stored at the database server 150.

The support server 140 may include a machine learning model trained on historical support ticket and solution data from the database server 150. Once trained, the machine learning model may be used by the support server 140 to determine an appropriate support group to handle new support tickets.

The application running on the application server 130 provides services to the client devices 160A and 160B. For example, a user of the client device 160A may be an employee of a business using a business application. The user may use the services to generate invoices, manage employees, develop other applications, or any suitable combination thereof. The user interface for the application may be presented using a web interface 170 or an app interface 180.

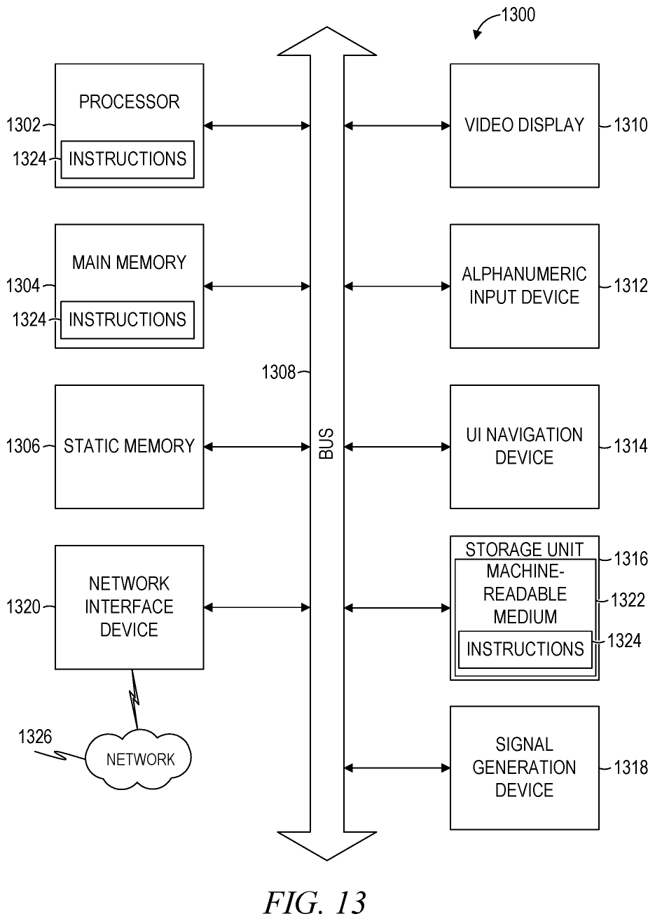

The application server 130, the support server 140, the database server 150, and the client devices 160A-160B may each be implemented in a computer system, in whole or in part, as described below with respect to FIG. 13. Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 13. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIG. 1 may be combined into a single machine, database, or device, and the functions described herein for any single machine, database, or device may be subdivided among multiple machines, databases, or devices.

The application server 130, the support server 140, the database server 150, and the client devices 160A-160B are connected by the network 190. The network 190 may be any network that enables communication between or among machines, databases, and devices. Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

Though FIG. 1 shows only one or two of each element (e.g., one application server 130, two client devices 160A and 160B, and the like), any number of each element is contemplated. For example, the application server 130 may be one of dozens or hundreds of active and standby servers and provide services to millions of client devices. Likewise, the support server 140 may access data from dozens or hundreds of database servers and file servers, be used by many application servers 130, and so on.

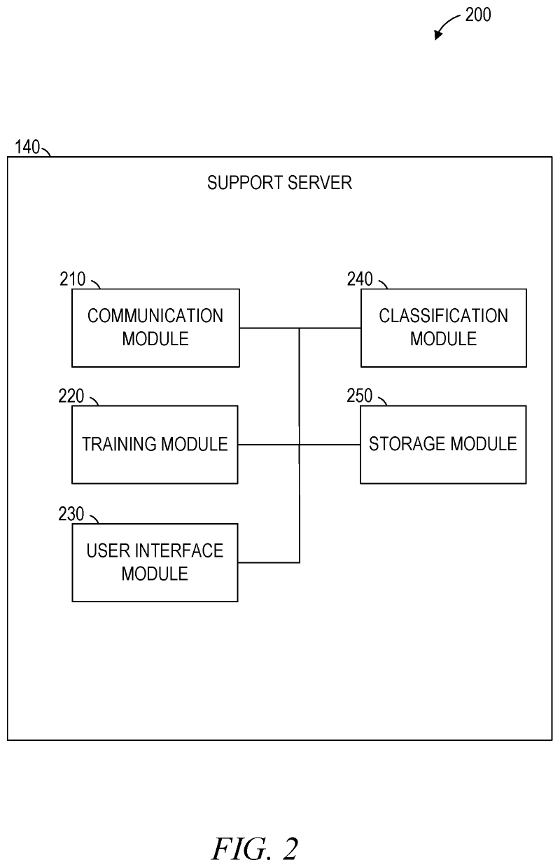

FIG. 2 shows a block diagram 200 of the support server 140, suitable for model stacking for support ticket categorization. The support server 140 is shown as including a communication module 210, a training module 220, a user interface module 230, a classification module 240, and a storage module 250, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, modules described herein as being implemented within a single machine, database, or device may be distributed across multiple machines, databases, or devices.

The communication module 210 receives data sent to the support server 140 and transmits data from the support server 140. For example, the communication module 210 may receive, from the client device 150A, a support ticket. In response, the communication module 210 provides the support ticket to the classification module 240. The communication module 210 may also send requests to the database server 150 for training data to be used by the training module 220.

The training module 220 trains a machine-learning model of the classification module 240. The training includes providing a training set of annotated documents to the machine-learning model. The annotated documents may comprise historical support tickets annotated with data identifying the support group that successfully handled each support ticket.

The classification module 240 determines, for a given support ticket, a support group to handle the support ticket. The classification module 240 may use a model stack comprising multiple machine-learning models.

Data, metadata, documents, instructions, or any suitable combination thereof may be stored and accessed by the storage module 250. For example, local storage of the support server 140, such as a hard drive, may be used. As another example, network storage may be accessed by the storage module 250 via the network 190.

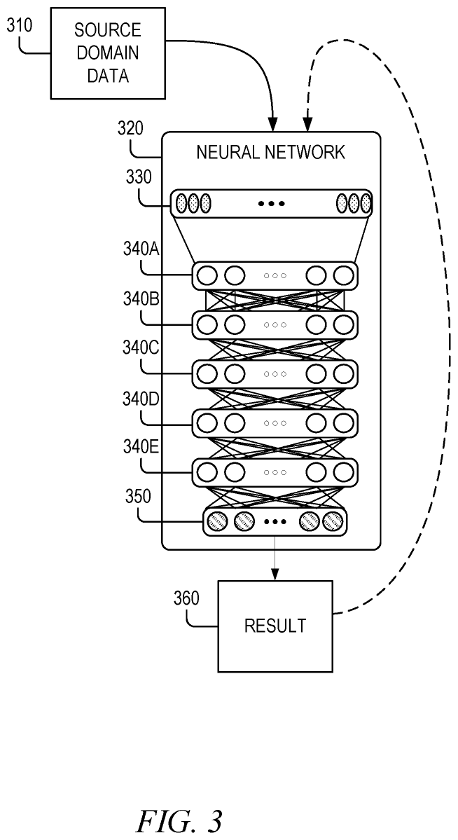

FIG. 3 is a block diagram of a neural network 320, suitable for use as a model in a model stack for support ticket categorization, according to some example embodiments. The neural network 320 takes source domain data 310 as input and processes the source domain data 310 using an input layer 330; intermediate, hidden layers 340A, 340B, 340C, 340D, and 340E; and output layer 350 to generate a result 360.

A neural network, sometimes referred to as an artificial neural network, is a computing system based on consideration of biological neural networks of animal brains. Such systems progressively improve performance, which is referred to as learning, to perform tasks, typically without task-specific programming. For example, in image recognition, a neural network may be taught to identify images that contain an object by analyzing example images that have been tagged with a name for the object and having learned the object and name, may use the analytic results to identify the object in untagged images.

A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

Each of the layers 330-350 comprises one or more nodes (or “neurons”). The nodes of the neural network 320 are shown as circles or ovals in FIG. 3. Each node takes one or more input values, processes the input values using zero or more internal variables, and generates one or more output values. The inputs to the input layer 330 are values from the source domain data 310. The output of the output layer 350 is the result 360. The intermediate layers 340A-340E are referred to as “hidden” because they do not interact directly with either the input or the output and are completely internal to the neural network 320. Though five hidden layers are shown in FIG. 3, more or fewer hidden layers may be used.

A model may be run against a training dataset for several epochs, in which the training dataset is repeatedly fed into the model to refine its results. In each epoch, the entire training dataset is used to train the model. Multiple epochs (e.g., iterations over the entire training dataset) may be used to train the model. In some example embodiments, the number of epochs is 10, 100, 500, or 1000. Within an epoch, one or more batches of the training dataset are used to train the model. Thus, the batch size ranges between one and the size of the training dataset while the number of epochs is any positive integer value. The model parameters are updated after each batch (e.g., using gradient descent).

For self-supervised learning, the training dataset comprises self-labeled input examples. For example, a set of color images could be automatically converted to black-and-white images. Each color image may be used as a “label” for the corresponding black-and-white image and used to train a model that colorizes black-and-white images. This process is self-supervised because no additional information, outside of the original images, is used to generate the training dataset. Similarly, when text is provided by a user, one word in a sentence can be masked and the network trained to predict the masked word based on the remaining words.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the nth epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusters is used to select a model that produces the clearest bounds for its clusters of data.

The neural network 320 may be a deep learning neural network, a deep convolutional neural network (CNN), a recurrent neural network, a transformer neural network, or another type of neural network. A neuron is an architectural element used in data processing and artificial intelligence, particularly machine learning. A neuron implements a transfer function by which a number of inputs are used to generate an output. In some example embodiments, the inputs are weighted and summed, with the result compared to a threshold to determine if the neuron should generate an output signal (e.g., a 1) or not (e.g., a 0 output). The inputs of the component neurons are modified through the training of a neural network. One of skill in the art will appreciate that neurons and neural networks may be constructed programmatically (e.g., via software instructions) or via specialized hardware linking each neuron to form the neural network.

An example type of layer in the neural network 320 is a Long Short Term Memory (LSTM) layer. An LSTM layer includes several gates to handle input vectors (e.g., time-series data), a memory cell, and an output vector. The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input. Thus, the coefficients assign significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight updates. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

In some example embodiments, the structure of each layer is predefined. For example, a convolution layer may contain small convolution kernels and their respective convolution parameters, and a summation layer may calculate the sum, or the weighted sum, of two or more values. Training assists in defining the weight coefficients for the summation.

One way to improve the performance of DNNs is to identify newer structures for the feature-extraction layers, and another way is by improving the way the parameters are identified at the different layers for accomplishing a desired task. For a given neural network, there may be millions of parameters to be optimized. Trying to optimize all these parameters from scratch may take hours, days, or even weeks, depending on the amount of computing resources available and the amount of data in the training set.

One of ordinary skill in the art will be familiar with several machine learning algorithms that may be applied with the present disclosure, including linear regression, random forests, decision tree learning, neural networks, DNNs, genetic or evolutionary algorithms, and the like.

With the help of natural language processing (NLP) and advanced data pre-processing, a machine learning model (e.g., the neural network 320) can be trained on historical (existing) data (for instance, support tickets) from the system to assign them with a support group based on textual fields such as description, subject, and so forth.

The transformer architecture processes an entire input at once rather than sequentially. For example, a recurrent neural network (RNN) processes words or sentences sequentially, with the output of the RNN treated as an input for each input after the first (thus the use of the word “recurrent” in the name). As a result, relationships between elements that are far apart in the input are difficult to detect. The transformer architecture receives a larger input and learns the interrelationships between the elements and the output using an attention mechanism. Since all elements are processed together, distance between the elements of the input does not affect the learning process. The output may still be generated sequentially, with the previous result (e.g., word for an LLM, pixel for an image-generating artificial intelligence, and the like) being provided as an input for determination of the next result.

The neural network 320 may be used for categorizing data. For example, the training data may include inputs comprising support tickets. The corresponding outputs may be the corresponding support groups. After training, when the neural network receives a support ticket as input, it generates output that identifies a support group for the support ticket.

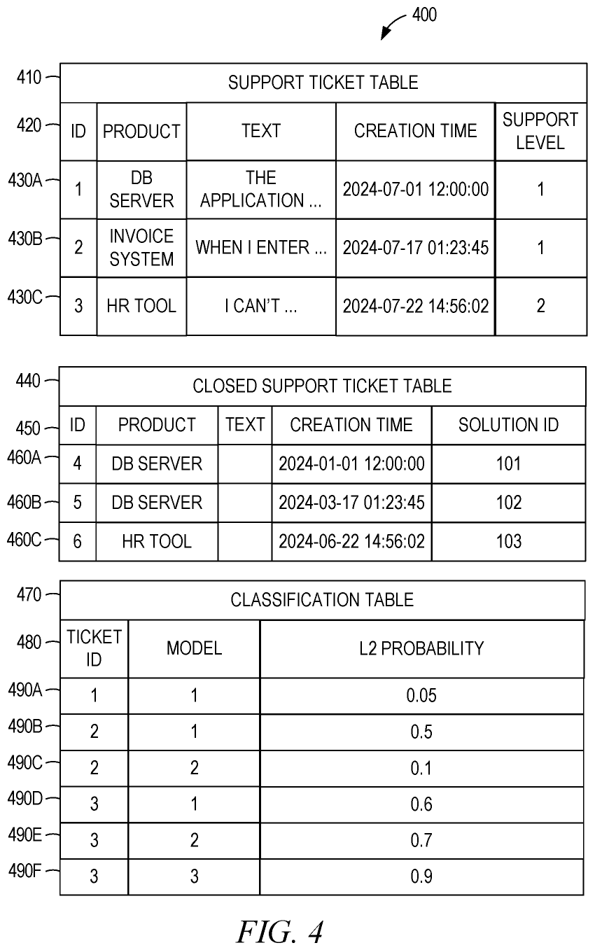

FIG. 4 shows an illustration of an example database schema 400, suitable for training models suitable for use in a model stack for support ticket categorization. The database schema 400 includes a support ticket table 410, a closed support ticket table 440, and a classification table 470. The support ticket table 410 includes rows 430A, 430B, and 430C of a format 420. The closed support ticket table 440 includes rows 460A, 460B, and 460C of a format 450. The classification table 470 includes rows 490A, 490B, 490C, 490D, 490E, and 490F of a format 480.

Each of the rows 430A-430C of the support ticket table 410 includes a unique identifier for a support ticket, a product the support ticket applies to, text provided by the user that submitted the support ticket, a date/time at which the support ticket was created, and a current support level of a support group to which the support ticket is assigned, as indicated by the format 420. In the example of

FIG. 4, each of the support tickets of the support ticket table 410 is for a different product. The support tickets of the row 430A and 430B are assigned to a first support level. The support ticket of the row 430C is assigned to a second support level.

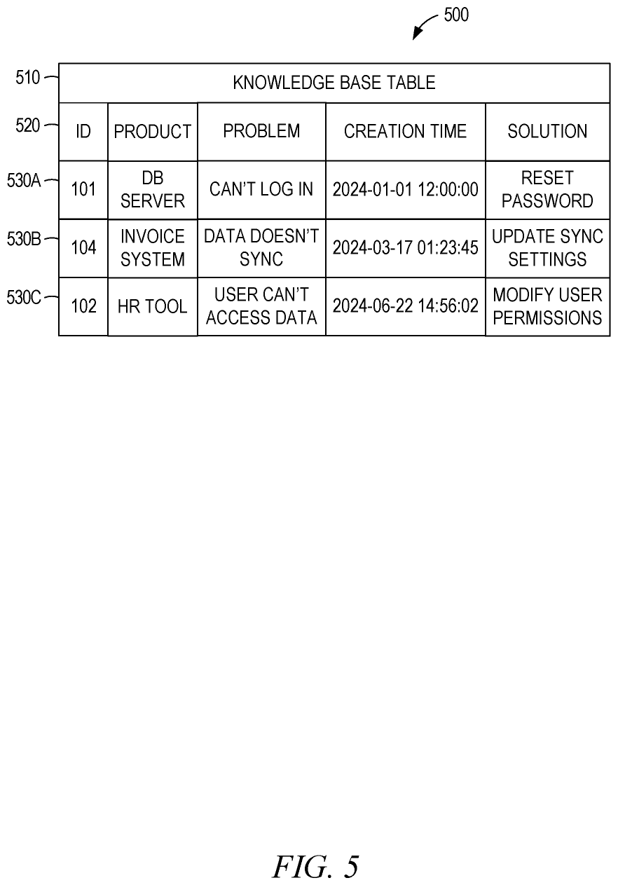

The closed support ticket table 440 stores data for closed support tickets, including the unique identifier for the support ticket, the product the support ticket applies to, the text provided by the user that submitted the support ticket, the creation time of the support ticket, and an identifier of the solution that resolved the support ticket. The solution identifier may be cross-referenced with a knowledge base, discussed in more detail with respect to FIG. 5.

The support ticket table 410, the closed support ticket table 440, or both, may include more or fewer fields than shown in FIG. 4. Example additional fields include: a component of the product, an identifier of a customer that created the support ticket, one or more identifiers of suggested solutions for the support ticket, communication logs of communications between support staff and the customer regarding the support ticket, a resolution time of the support ticket, or any suitable combination thereof.

The format 480 of the classification table 470 indicates that each of the rows 490A-490F includes a probability that a support ticket will be assigned to L2 support (e.g., the second support level), an identifier of the support ticket being classified, and an identifier of the model that generated the probability. Using a model stack, some support tickets may be classified by more models than others. For example, the row 490A indicates that a first model classified the support ticket of the row 430A as belonging to L2 support with only 0.05 probability. Thus, the first model determines that the support ticket will be successfully handled by L1 support with 95% likelihood. The probability may be compared to a predetermined threshold (e.g., 0.10 or 10%), such that probabilities of L2 support in the range 0.1 to 0.9 are considered inconclusive and the same support ticket is processed by the next model in the stack. In the case of the row 490A, the confidence of first model is such that the support ticket is routed to L1 support and no further models are run.

The rows 490B-490C are for the support ticket of the row 430B. In this example, the first model determined an L2 probability of 0.5. When only two levels of support are used, this indicates that the model finds the probability of correct assignment to L1 and correct assignment to L2 to be equal. Since the result of the first model is indeterminate, the support ticket of the row 430B is provided to a second model. In this example, the second model determined an L2 probability of 0.1, which may be sufficient to assign the support ticket to L1 support, depending on the predetermined threshold used.

The probabilities generated by three models for the support ticket of the row 430C are shown in the rows 490D-490F. In this example, the probabilities generated by the first two models were insufficient to determine which support group to send the support ticket to. The third model determined with 90% confidence that the support ticket should be assigned to L2 support, which may be sufficient to assign the support ticket to L2 support, depending on the predetermined threshold used.

FIG. 5 shows an illustration of an example database schema 500, suitable for use in addressing support tickets. The database schema 500 includes a knowledge base table 510. The knowledge base table 510 includes rows 530A, 530B, and 530C of a format 520.

Each of the rows 530A-450C of the knowledge base table 510 includes a unique identifier for a KBA, a product the KBA applies to, an identification of a problem with the product, a creation time of the solution, and a solution for the problem, as indicated by the format 520. In the example of FIG. 5, each of the KBAs of the knowledge base table 510 is for a different product. A first level support group may access data from the knowledge base table 510 to assist users in resolving support tickets. When no solution for a support ticket is found in the knowledge base table 510, the first level support group may escalate the support ticket to a second level support group.

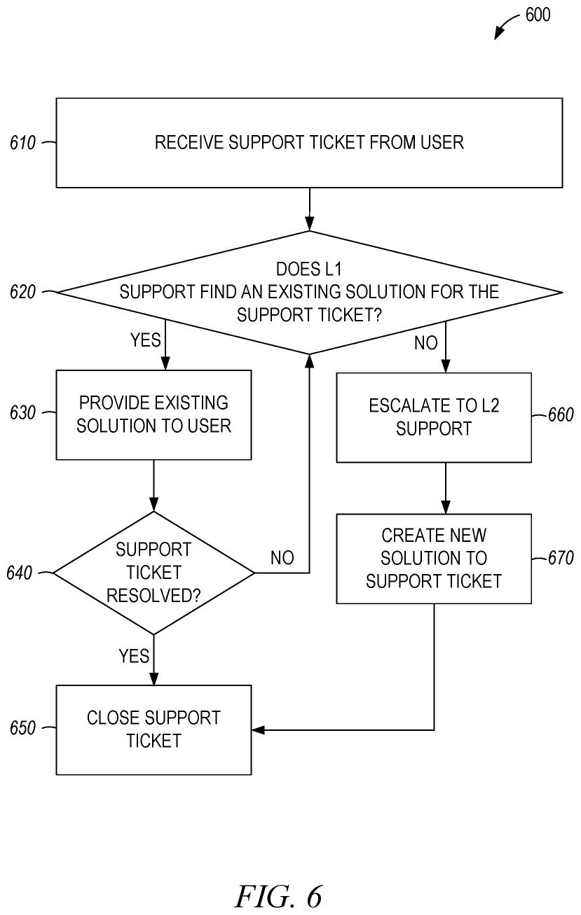

FIG. 6 shows a flowchart illustrating a method 600 of handling support tickets without using model stacking for support ticket categorization. The method 600 includes operations 610, 620, 630, 640, 650, 660, and 670.

In operation 610, a support center receives a support ticket from a user. For example, the user may enter text describing a problem into a web form. The support ticket is initially assigned to L1 support. In operation 620, L1 support attempts to find an existing solution to the problem (e.g., by accessing the knowledge base table 510 of the FIG. 5). If L1 support is successful in finding an existing solution, L1 support provides the existing solution to the user (operation 630).

If the provided solution resolves the support ticket, in operation 640, the support ticket is closed (operation 650). Otherwise, the method 600 returns to the operation 620 and L1 support continues searching for existing solutions. Operations 620-640 repeat until either no additional solutions are found or the support ticket is closed.

In operation 620, if no existing solution for the support ticket is found, L1 support transfers the support ticket to L2 support (operation 660). L2 support creates a new solution to the support ticket in operation 670. The new solution may involve adding a new article to a knowledge base, creating a new software tool that the user can run to solve the problem, modifying source code of the product that the support ticket applies to, or any suitable combination thereof. The new solution is used to address the problem raised in the support ticket and the support ticket is closed in operation 650.

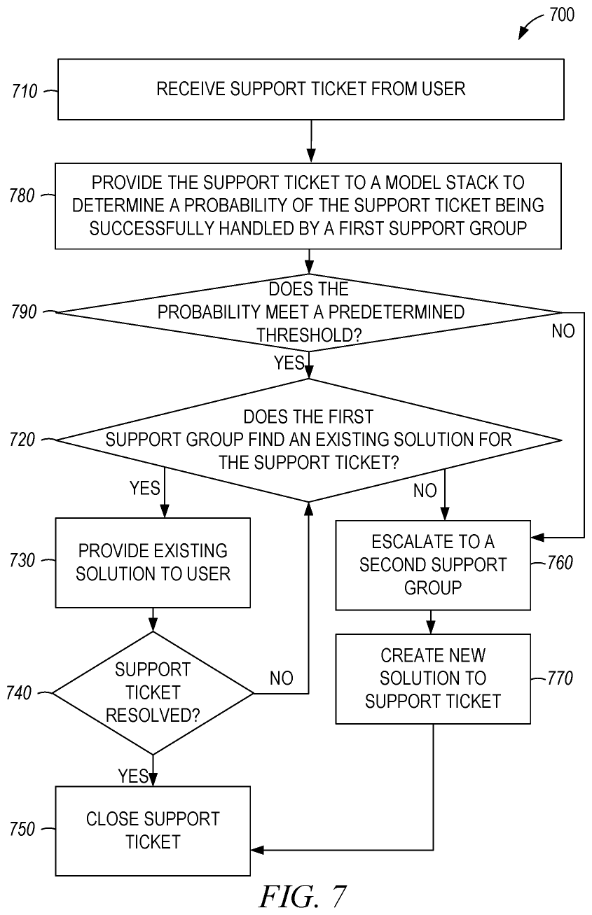

The method 600 is efficient if only a few support tickets cannot successfully be handled by L1 support. However, for large software organizations that handle thousands or millions of support requests annually, even if only 10% of support tickets are escalated to L2 support, L1 support is attempting to solve hundreds or thousands of support tickets that will eventually be escalated. Accordingly, such organizations benefit from replacing the method 600 with the method 700 of FIG. 7, in which some support tickets are escalated to L2 support without first being handled by L1 support.

FIG. 7 shows a flowchart illustrating a method 700 of handling support tickets using model stacking for support ticket categorization. The method 700 includes operations 710, 720, 730, 740, 750, 760, 770, 780, and 790. Operations 710-770 correspond to operations 610-670, described above with respect to FIG. 6. Operations 780 and 790 are inserted between operations 710 and 720. By way of example and not limitation, the method 700 is described as being performed by the support server 140 of FIG. 1, using the modules of FIG. 2, the neural network of FIG. 3, and the database schemas of FIG. 4 and FIG. 5.

In operation 710, the support server 140 receives a support ticket from a user (e.g., via the communication module 210). The communication module 210 provides the support ticket, in operation 780, to a model stack to determine a probability of the support ticket being successfully handled by a first support group (e.g., L1 support). In some example embodiments, the result from the model stack is a probability of the support ticket not being successfully handled by the first support group. The two values are easily convertible (e.g., by subtraction from 100%).

In operation 790, the determined probability is compared to a predetermined threshold and the support ticket is routed either to the first support group (operation 720) or to a second support group (operation 760). If the method 700 proceeds with operation 720, the first support group attempts to resolve the support ticket in operations 720-740. If the first support group successfully resolves the support ticket, the support ticket is closed in operation 750.

If the first support group is unable to resolve the support ticket, the support ticket is escalated to the second support group and the method 700 proceeds with the operation 760. Note that if the model stack determined that the first support group was unlikely to be able to resolve the support ticket, operations 720-740 are bypassed, improving the efficiency of support staff. The second support group creates a new solution to the support ticket (operation 770) and closes the support ticket (operation 750).

In some example embodiments, more than two support groups are used. In such embodiments, operation 790 may route the support ticket to any one of the multiple support groups.

Using the method 600 of FIG. 6, there is no way to identify whether a support ticket will be solved by existing solutions or will need a new fix. As a result, the identification is made by L1 support after attempting to resolve the problem. Using the method 700 of FIG. 7, a trained machine learning model categorizes the incoming support tickets, reducing the cost and effort of L1 support, the time between when a support ticket is submitted and it begins to be handled by L2 support, and the total time and effort spent in resolving support tickets that are ultimately handled by L2 support.

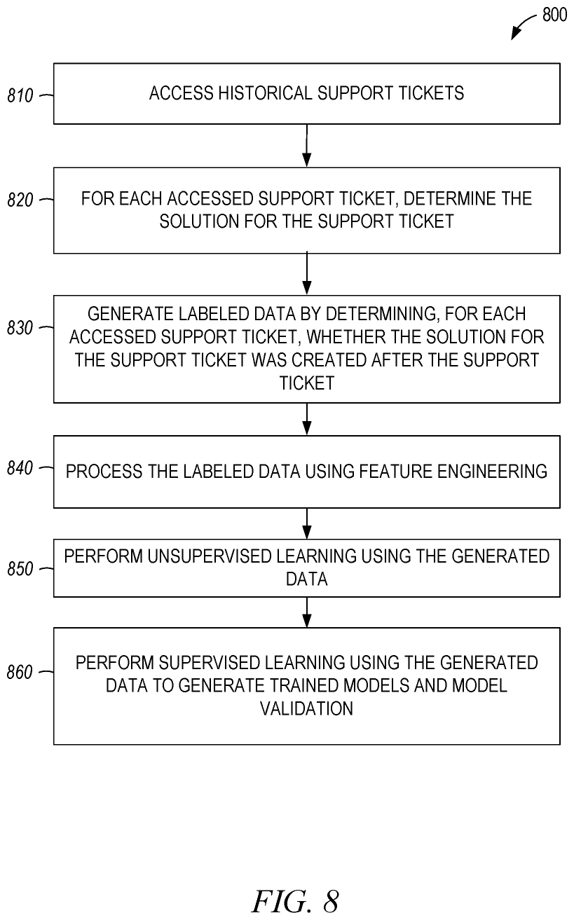

FIG. 8 shows a flowchart illustrating a method 800 of generating models suitable for use in a model stack for support ticket categorization. The method 800 includes operations 810, 820, 830, 840, 850, and 860. By way of example and not limitation, the method 800 is described as being performed by the support server 140 of FIG. 1, using the modules of FIG. 2, the neural network of FIG. 3, and the database schemas of FIG. 4 and FIG. 5.

In operation 810, the training module 220 accesses a training set comprising historical support tickets. For example, data from the closed support ticket table 440 may be accessed. The training module 220, in operation 820, determines a solution for each accessed support ticket. Referring again to the closed support ticket table 440, the solution identifier column may be accessed to determine the solution.

The training module 220 generates labeled data by determining whether the solution for each support ticket was created after the support ticket (operation 830). The closed support ticket table 440 and the knowledge base table 510 each include a creation time column that indicates when the respective support tickets and KBAs were created. If the KBA was created before the support ticket, that shows that the support ticket was resolved by an existing solution and was properly handled by the first support group. If the KBA was created within the range of support ticket creation and closure, that shows that a new solution was created to resolve the support ticket and that the support ticket was properly handled by the second support group. In other example embodiments, the support group that closed a support ticket is part of the data stored in the closed support ticket table 440. Thus, each of the historical support tickets is labeled with a class that identifies a support group that resolved the historical support ticket.

If the number of support tickets in each class is not equal, the minority class is the class, of a set of available classes, used to label the fewest historical support tickets; the majority class is the class used to label the most historical support tickets. Thus, the number of support tickets in the majority class is greater than the number of support tickets in the minority class. For example, the minority class may comprise 10%, 30%, or fewer of the support tickets and the majority class 50%, 70%, or more of the support tickets.

The historical support tickets used to generate the labeled data may comprise all historical support tickets in the closed support ticket table 440 or a subset thereof. The subset may be generated by applying filters, such as selecting closed support tickets only for a particular product, a particular time frame (e.g., the past five years), or both.

In operation 840, the training model processes the labeled data using feature engineering. The text written by the user that creates a support ticket (e.g., in a title, in a description, or both) contains information about the problem faced by the user. Feature engineering may include tokenization, feature extraction, vectorization, or any suitable combination thereof.

Tokenization involves retaining the meaningful pieces of text (e.g., the text provided by the user) in the support ticket and discarding other portions. For example, hypertext markup language (HTML) tags and punctuation may be removed, template text automatically included in the support ticket submission processed may be removed, and stop words (common words such as “a,” “an,” and “the” that do not inform the meaning of the text) may be removed.

Feature extraction may include the creation of n-grams such as unigrams (1-grams), bigrams (2-grams), and trigrams (3-grams). The n-grams are extracted out of the tokenized text. The n-grams may be partitioned on the basis of labels such as “title” and “description.” The n-grams may be partitioned into three sets: one for n-grams that appear only in support tickets resolved by a first support group, one for n-grams that appear only in support tickets resolved by a second support group, and one for n-grams that appear in support tickets resolved by both support groups. If most support tickets are resolved by the first support group, the set of n-grams appearing only in support tickets resolved by the second support group may be the empty set. When more than two support groups are used, additional sets of n-grams may be created.

The extracted features may be vectorized using TF-IDF (term frequency-inverse document frequency), contextualization vectorization, or both. TF-IDF vectorizes a support ticket based solely on the occurrence of tokens (e.g., words), whereas contextual vectorization vectorizes the support ticket based on contextual understanding of the issue described in the support ticket.

In operation 850, the training module 220 performs unsupervised learning using the generated data. Unsupervised learning algorithms include topic modeling and document clustering. For example, topic modeling with TF-IDF vectors may be performed. As another example, document clustering with contextual embeddings may be performed.

After each unsupervised learning algorithm is applied, a mapper may be generated. For example, a mapper may determine the proportion of support tickets solved by each support group in each topic found using topic modeling. As another example, a mapper may determine the proportion of support tickets solved by each support group in each cluster found using document clustering. When most support tickets are resolved by one support group, there may be one or more topics or clusters that contain support tickets for only the majority class (e.g., the first support group). This information may be used to aid in classifying new tickets during the prediction phase.

The training module 220 performs supervised learning using the generated data to generate trained models and model validation (operation 860). Supervised learning algorithms such as gradient-boosted decision trees (GBDT) and neural networks may be used in this step. Multiple classifiers may be trained to generate a model stack. In some example embodiments, the model stack comprises a single model. The classifiers may be trained using a balanced log loss function, class weights, or any suitable combination thereof. The generation of the trained models includes providing a training set comprising historical support tickets in both operations 830 and 850.

The method 800 may be periodically repeated (e.g., monthly or annually). The trained models resulting from the most recent iteration of the method 800 may replace previous versions, allowing the system to stay up-to-date by learning from more recent data.

By way of example and not limitation, the validation of the model is described for an example embodiment with two classes of support tickets. Class 0 support tickets are those that are handled by a first support group. Class 1 support tickets are those that are handled by a second support group. Class 0 is larger than Class 1 (e.g., at least twice as large as Class 1, at least three times as large as Class 1, at least four times as large as Class 1, or at least ten times as large as Class 1).

Each model may be evaluated for precision and recall. Precision refers to the proportion of correct classifications out of the total records (in this case, support tickets) classified by the model as Class 1. Recall refers to the proportion of correct classifications out of the total records that are Class 1. Thus, validation of the model may include determining a proportion of correct classifications of the historical support tickets classified by the trained machine learning model as the minority class out of a total number of classifications of the historical support tickets classified by the trained machine learning model as the minority class. Additionally or alternatively, validation of the model may include determining a proportion of correct classifications of the historical support tickets classified by the trained machine learning model as the minority class out of a total number of the historical support tickets labeled as the minority class.

Log loss is a method of providing feedback to machine learning algorithms during training. Log loss measures the performance of a model by assigning a value to the difference between predicted probabilities and actual values. For example, consider a support ticket that is Class 1 and is provided to two models. The first model determines a zero probability that the support ticket is Class 1. The second model determines a 0.45 probability that the support ticket is Class 1. Neither model correctly classified the support ticket as being in Class 1 (e.g., by providing a probability greater than 0.5), but the first model is less correct than the second model. Accordingly, the internal variables of the first model should be adjusted more than the internal variables of the second model. Log loss accomplishes this.

Balanced log loss is a modified log loss function that weights the errors of classes in inverse proportion of their occurrences. Thus, a minority class classification error gets a higher penalty weight than a majority class classification error. As a result, the generating of a trained machine learning model using a balanced log loss function that penalizes misclassifications of the minority class more than misclassifications of the majority class causes the machine learning model to focus on learning classification of the minority class despite the relatively lower frequency of those examples in the training data.

For binary classification with a true label yϵ{0, 1} and a probability estimate p=Pr(y=1)

$$Balanced Log Loss = \frac{- 1}{{N}_{y}} [ y log ( p ) + ( 1 - y ) log ( 1 - p ) ]$$

where, N_{y}=Number of records of Class y.

In this example, since y is the true label, it always has a value of 0 or 1, indicating whether the support ticket was Class 0 or Class 1. The probability estimate, p, has a value in the range of 0 to 1, inclusive. Thus, the loss function is either proportional to log (p), for Class 1, or to log (1−p), for Class 0.

After the one or more models are generated and validated, the model stack is created by ordering the models based on computing resources consumed by the model. For example, the least resource-intensive model may be the first model in the model stack and the most resource-intensive model may be the last model in the model stack.

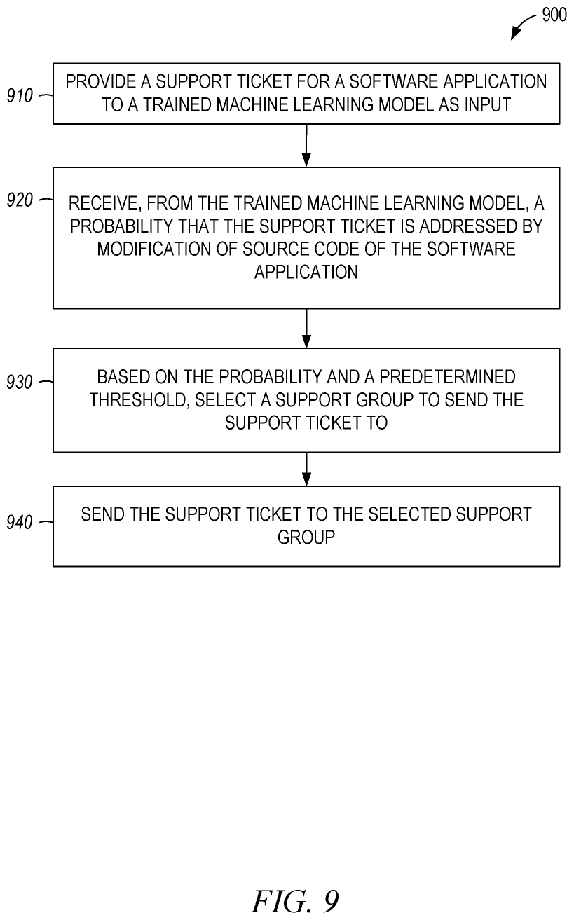

FIG. 9 shows a flowchart illustrating a method 900 of handling support tickets using model stacking for support ticket categorization. The method 900 includes operations 910, 920, 930, and 940. By way of example and not limitation, the method 900 is described as being performed by the support server 140 of FIG. 1, using the modules of FIG. 2, the neural network of FIG. 3, and the database schema of FIG. 4.

In operation 910, the classification module 240 provides a support ticket for a software application to a trained machine learning model (e.g., the neural network 320 of FIG. 3) as input. The classification module 240 receives, from the trained machine learning model, a probability that the support ticket is addressed by modification of source code of the software application, in operation 920. For example, the row 490A of the classification table 470, both of FIG. 4, indicates that a first model found the probability of the support ticket being properly addressed by L2 support is 0.05. Assuming, for the purposes of this example, that source code modification can be performed by L2 support and not by L1 support, and that all support tickets that do not require support code modification are handled by L1 support, this probability is a probability that the support ticket is addressed by modification of source code. Based on the probability and a predetermined threshold, the classification module 240 selects a support group to send the support ticket to (operation 930). For example, the L2 probability may be compared to a predetermined threshold of 0.1. Since the L2 probability is less than the predetermined threshold, the L1 support group is selected. In operation 940, the classification module 220 sends the support ticket to the selected support group.

As another example, the row 490F of the classification table 470 indicates that a third model found the probability of the support ticket being properly addressed by L2 support is 0.9. The L2 probability may be compared to a predetermined threshold of 0.8. Since the L2 probability is greater than the predetermined threshold, the L2 support group is selected.

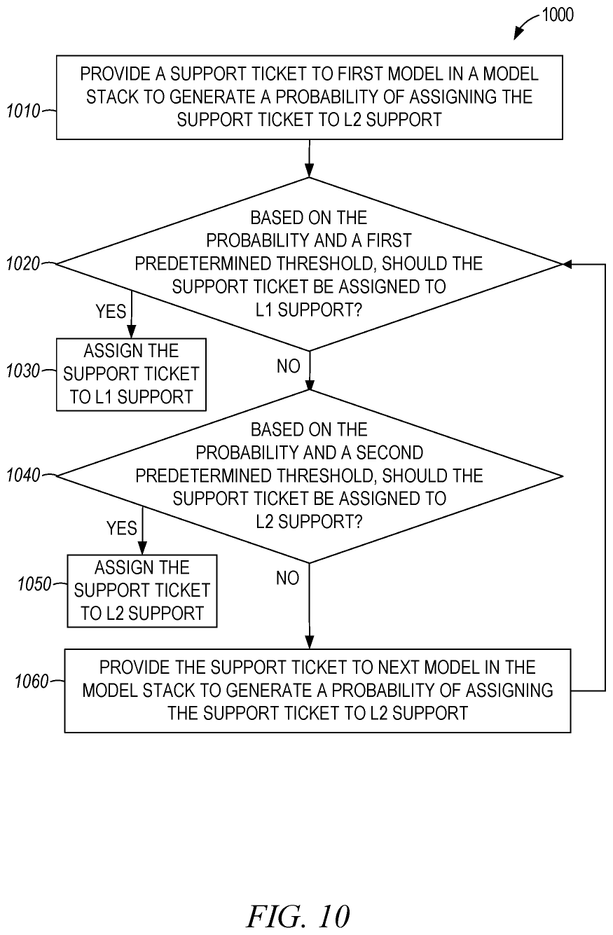

FIG. 10 shows a flowchart illustrating a method 1000 of handling support tickets using model stacking for support ticket categorization. The method 1000 includes operations 1010, 1020, 1030, 1040, 1050, and 1060. By way of example and not limitation, the method 1000 is described as being performed by the support server 140 of FIG. 1, using the modules of FIG. 2, the neural network of FIG. 3, and the database schema of FIG. 4.

In operation 1010, the classification module 240 provides a support ticket for a software application to a first model in a model stack to generate a probability of assigning the support ticket to L2 support. For example, the support ticket of the row 430B in the support ticket table 410 of FIG. 4 may be provided to the first model (having identifier 1) in a model stack. As indicated by the row 490B of the classification table 470, also of FIG. 4, the resulting probability is 0.5.

Based on the probability and a first predetermined threshold (e.g., 0.1), the classification module 240 determines if the support ticket should be assigned to L1 support (operation 1020). In this example, the probability that the support ticket should be assigned to L2 support is 0.5, which is greater than the first predetermined threshold, and the support ticket should not be assigned to L1 support. Accordingly, the method proceeds to operation 1040.

In operation 1040, the classification module 240 determines, based on the probability and a second predetermined threshold (e.g., 0.9), if the support ticket should be assigned to L2 support. In this example, the probability that the support ticket should be assigned to L2 support is 0.5, which dis less than the second predetermined threshold, and the support ticket should not be assigned to L2 support. Accordingly, the method proceeds to operation 1060.

The classification module 240, in operation 1060, provides the support ticket to the next model in the model stack to generate a probability of assigning the support ticket to L2 support. For example, the support ticket of the row 430B in the support ticket table 410 of FIG. 4 may be provided to the second model (having identifier 2) in the model stack. With reference to the row 490C of the classification table 470, the probability that the support ticket should be assigned to L2 support is 0.1. Thus, the providing of the support ticket for to the second machine learning model is based on the probability determined by the first machine learning model, the first predetermined threshold, and the second predetermined threshold. After operation 1060, the method 1000 returns to the operation 1020.

In the second iteration of operation 1020, the classification module 240 determines, based on the probability for the current model in the model stack and the first predetermined threshold, if the support ticket should be assigned to L1 support. In this case, since the probability is less than or equal to the first threshold, the support ticket should be assigned to L1 support. Accordingly, in operation 1030, the support ticket is assigned to L1 support.

As another example, consider the support ticket of the row 430C of the support ticket table 410, with classification probabilities shown in the rows 490D-490F of the classification table 470, all of FIG. 4. In this example, neither the first model nor the second model provides a probability that is sufficient for assignment. However, the third model provides an L2 probability of 0.9. Accordingly, in the third iteration of operation 1040, the classification module 240 determines that the probability is greater than or equal to the second predetermined threshold and, in operation 1050, the support ticket is assigned to L2 support.

In some example embodiments, the first predetermined threshold, the second predetermined threshold, or both, vary based on the model. For example, the last model in the model stack may use an equal value (e.g., of 0.5) for both the first threshold and the second threshold, ensuring that the support ticket is assigned to one support group or the other. If the support ticket is not assigned to a support group and operation 1060 cannot be performed because there are no remaining models in the model stack, the classification module 240 may assign the support ticket to a default support group (e.g., L1 support).

The models in the model stack may be arranged in a sequence that begins with the simplest model, contains intermediate models sorted by complexity, and ends with the most complex model. For example, the second model used in the method 1000 may be more complex than the first model and simpler than the third model. Simpler models may consume fewer computing resources, but only be able to generate a clear answer for a subset of possible inputs. More complex models may be able to generate a clear answer for a larger range of possible inputs, but consume more computing resources. Models of lower complexity may include rules-based systems and GBDTs. Models of higher complexity may include trained machine learning models (e.g., CNNs) of increasing numbers of nodes.

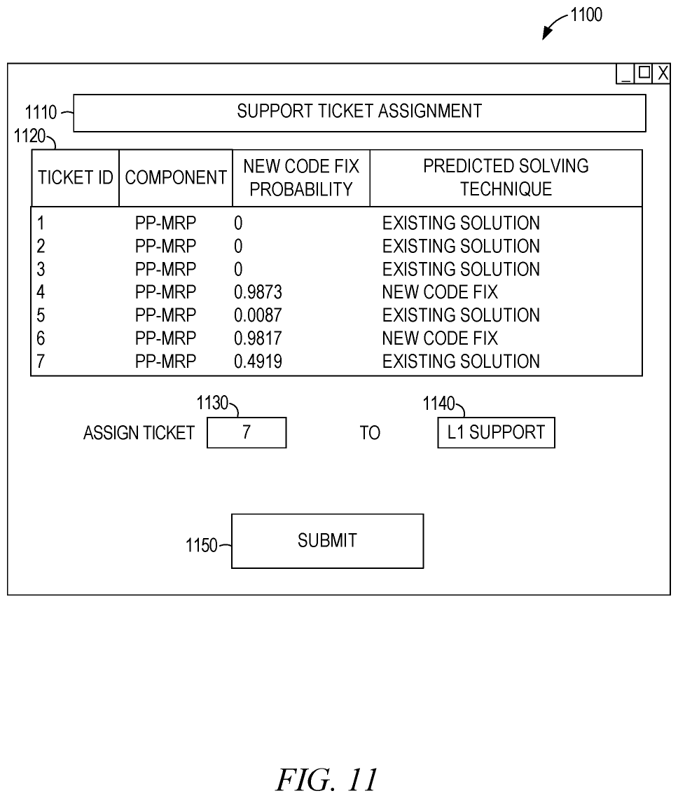

As an alternative to assigning the support ticket to a support group in operations 1030 and 1050, the method 1000 may terminate by accepting the probability generated by the model based on the first or second predetermined threshold, preventing the support ticket from being processed by the remaining models in the model stack. The resulting probability may be presented to a user in a user interface (e.g., the user interface 1100 of FIG. 11, discussed below), allowing the user to consider the probability in determining which support group to assign the ticket to.

FIG. 11 shows an illustration of an example user interface 1100 for assigning support tickets to support groups. The user interface 1100 may be generated by the support server 140 and presented on a display device of the client device 160A or 160B, all of FIG. 1. The user interface 1100 may be presented as part of operation 930 of FIG. 9, in which a support group is selected for a support ticket. Alternatively, operation 930 may be performed automatically, without use of the user interface 1100. The user interface 1100 includes a title 1110, an informational area 1120, input fields 1130 and 1140, and a button 1150.

The title 1110 indicates that the user interface 1100 is for assigning support tickets. The informational area 1120 shows information for several support tickets, including a ticket identifier for each ticket, a software component against which the ticket was raised, a probability that a new code fix will be needed to resolve the support ticket, and a predicted solving technique for the support ticket.

The new code fix probability value may be generated in operation 920 of FIG. 9 or operations 1020 and 1040 of FIG. 10. Based on the new code fix probability, a level of loading of each support group, or any suitable combination thereof, a user determines to assign one or more support tickets to one or more support groups. The user may indicate a selected ticket using the input field 1130 and the support group for the selected ticket using the input field 1140. The support server 140 receives the indicated selections and, in response to operation of the button 1150, assigns the selected ticket to the selected support group.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: a memory that stores instructions; and one or more processors coupled to the memory and configured to execute the instructions to perform operations comprising: providing a support ticket for a software application to a trained machine learning model as input; receiving, from the trained machine learning model, a probability that the support ticket is addressed by modification of source code of the software application; based on the probability and a predetermined threshold, selecting a support group to send the support ticket to; and sending the support ticket to the selected support group.

In Example 2, the subject matter of Example 1, wherein the operations further comprise: generating the trained machine learning model by providing a training set comprising a set of historical support tickets, each of the historical support tickets labeled with a class of a set of classes comprising a minority class and a majority class, more of the historical support tickets having majority class labels than minority class labels.

In Example 3, the subject matter of Example 2, wherein the class that labels each historical support ticket identifies a support group that resolved the historical support ticket.

In Example 4, the subject matter of Examples 2-3, wherein the operations further comprise: validating the trained machine learning model by determining a proportion of correct classifications of the historical support tickets classified by the trained machine learning model as the minority class out of a total number of classifications of the historical support tickets classified by the trained machine learning model as the minority class.

In Example 5, the subject matter of Examples 2-4, wherein the operations further comprise: validating the trained machine learning model by determining a proportion of correct classifications of the historical support tickets classified by the trained machine learning model as the minority class out of a total number of the historical support tickets labeled as the minority class.

In Example 6, the subject matter of Example 5, wherein the minority class comprises no more than 10% of the support tickets and the majority class comprises at least 70% of the support tickets.

In Example 7, the subject matter of Example 6, wherein the generating of the trained machine learning model comprises applying a balanced log loss function that penalizes misclassifications of the minority class more than misclassifications of the majority class.

In Example 8, the subject matter of Examples 1-7, wherein: the trained machine learning model is a second machine learning model; the probability that the support ticket is addressed by modification of source code of the software application is a second probability; the predetermined threshold is a second predetermined threshold; the operations further comprise: providing the support ticket for a software application to a first trained machine learning model as input; and receiving, from the first trained machine learning model, a first probability that the support ticket is addressed by modification of source code of the software application; and the providing of the support ticket for the software application to the second machine learning model is based on the first probability and a first predetermined threshold.

In Example 9, the subject matter of Example 8, wherein the first machine learning model is a simpler model than the second machine learning model.

Example 10 is a non-transitory computer-readable medium that stores instructions that, when executed by one or more processors, cause the one or more processors to perform operations comprising: providing a support ticket for a software application to a trained machine learning model as input; receiving, from the trained machine learning model, a probability that the support ticket is addressed by modification of source code of the software application; based on the probability and a predetermined threshold, selecting a support group to send the support ticket to; and sending the support ticket to the selected support group.

In Example 11, the subject matter of Example 10, wherein the operations further comprise: generating the trained machine learning model by providing a training set comprising a set of historical support tickets, each of the historical support tickets labeled with a class of a set of classes comprising a minority class and a majority class, more of the historical support tickets having majority class labels than minority class labels.

In Example 12, the subject matter of Example 11, wherein the class that labels each historical support ticket identifies a support group that resolved the historical support ticket.

In Example 13, the subject matter of Examples 11-12, wherein the operations further comprise: validating the trained machine learning model by determining a proportion of correct classifications of the historical support tickets classified by the trained machine learning model as the minority class out of a total number of classifications of the historical support tickets classified by the trained machine learning model as the minority class.

In Example 14, the subject matter of Examples 11-13, wherein the operations further comprise: validating the trained machine learning model by determining a proportion of correct classifications of the historical support tickets classified by the trained machine learning model as the minority class out of a total number of the historical support tickets labeled as the minority class.

In Example 15, the subject matter of Example 14, wherein the minority class comprises no more than 10% of the support tickets and the majority class comprises at least 70% of the support tickets.

In Example 16, the subject matter of Example 15, wherein the generating of the trained machine learning model comprises applying a balanced log loss function that penalizes misclassifications of the minority class more than misclassifications of the majority class.

Example 17 is a method comprising: providing, by one or more processors, a support ticket for a software application to a trained machine learning model as input; receiving, from the trained machine learning model, a probability that the support ticket is addressed by modification of source code of the software application; based on the probability and a predetermined threshold, selecting a support group to send the support ticket to; and sending, by the one or more processors, the support ticket to the selected support group.

In Example 18, the subject matter of Example 17 includes generating the trained machine learning model by providing a training set comprising a set of historical support tickets, each of the historical support tickets labeled with a class of a set of classes comprising a minority class and a majority class, more of the historical support tickets having majority class labels than minority class labels.

In Example 19, the subject matter of Example 18, wherein the class that labels each historical support ticket identifies a support group that resolved the historical support ticket.

In Example 20, the subject matter of Examples 18-19 includes validating the trained machine learning model by determining a proportion of correct classifications of the historical support tickets classified by the trained machine learning model as the minority class out of a total number of classifications of the historical support tickets classified by the trained machine learning model as the minority class.

Example 21 is an apparatus comprising means to implement any of Examples 1-20.

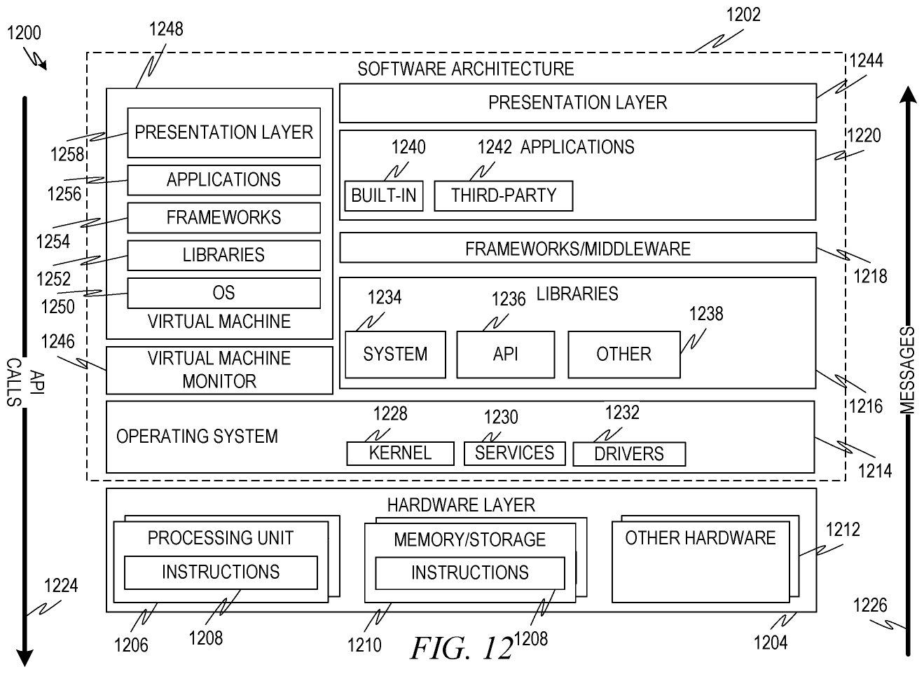

FIG. 12 shows a block diagram 1200 showing one example of a software architecture 1202 for a computing device. The software architecture 1202 may be used in conjunction with various hardware architectures, for example, as described herein. FIG. 12 is merely a non-limiting example of a software architecture, and many other architectures may be implemented to facilitate the functionality described herein. A representative hardware layer 1204 is illustrated and can represent, for example, any of the above referenced computing devices. In some examples, the hardware layer 1204 may be implemented according to the architecture of the computer system of FIG. 12.

The representative hardware layer 1204 comprises one or more processing units 1206 having associated executable instructions 1208. Executable instructions 1208 represent the executable instructions of the software architecture 1202, including implementation of the methods, modules, subsystems, and components, and so forth described herein and may also include memory and/or storage modules 1210, which also have executable instructions 1208. Hardware layer 1204 may also comprise other hardware as indicated by other hardware 1212 which represents any other hardware of the hardware layer 1204, such as the other hardware illustrated as part of the software architecture 1202.

In the example architecture of FIG. 12, the software architecture 1202 may be conceptualized as a stack of layers where each layer provides particular functionality. For example, the software architecture 1202 may include layers such as an operating system 1214, libraries 1216, frameworks/middleware 1218, applications 1220, and presentation layer 1244. Operationally, the applications 1220 and/or other components within the layers may invoke application programming interface (API) calls 1224 through the software stack and access a response, returned values, and so forth illustrated as messages 1226 in response to the API calls 1224. The layers illustrated are representative in nature and not all software architectures have all layers. For example, some mobile or special purpose operating systems may not provide a frameworks/middleware 1218 layer, while others may provide such a layer. Other software architectures may include additional or different layers.

The operating system 1214 may manage hardware resources and provide common services. The operating system 1214 may include, for example, a kernel 1228, services 1230, and drivers 1232. The kernel 1228 may act as an abstraction layer between the hardware and the other software layers. For example, the kernel 1228 may be responsible for memory management, processor management (e.g., scheduling), component management, networking, security settings, and so on. The services 1230 may provide other common services for the other software layers. In some examples, the services 1230 include an interrupt service. The interrupt service may detect the receipt of an interrupt and, in response, cause the software architecture 1202 to pause its current processing and execute an interrupt service routine (ISR) when an interrupt is accessed.

The drivers 1232 may be responsible for controlling or interfacing with the underlying hardware. For instance, the drivers 1232 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 1216 may provide a common infrastructure that may be utilized by the applications 1220 and/or other components and/or layers. The libraries 1216 typically provide functionality that allows other software modules to perform tasks in an easier fashion than to interface directly with the underlying operating system 1214 functionality (e.g., kernel 1228, services 1230 and/or drivers 1232). The libraries 1216 may include system libraries 1234 (e.g., C standard library) that may provide functions such as memory allocation functions, string manipulation functions, mathematic functions, and the like. In addition, the libraries 1216 may include API libraries 1236 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 1216 may also include a wide variety of other libraries 1238 to provide many other APIs to the applications 1220 and other software components/modules.

The frameworks/middleware 1218 may provide a higher-level common infrastructure that may be utilized by the applications 1220 and/or other software components/modules. For example, the frameworks/middleware 1218 may provide various graphic user interface (GUI) functions, high-level resource management, high-level location services, and so forth. The frameworks/middleware 1218 may provide a broad spectrum of other APIs that may be utilized by the applications 1220 and/or other software components/modules, some of which may be specific to a particular operating system or platform.

The applications 1220 include built-in applications 1240 and/or third-party applications 1242. Examples of representative built-in applications 1240 may include, but are not limited to, a contacts application, a browser application, a book reader application, a location application, a media application, a messaging application, and/or a game application. Third-party applications 1242 may include any of the built-in applications as well as a broad assortment of other applications. In a specific example, the third-party application 1242 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 1242 may invoke the API calls 1224 provided by the mobile operating system such as operating system 1214 to facilitate functionality described herein.

The applications 1220 may utilize built in operating system functions (e.g., kernel 1228, services 1230 and/or drivers 1232), libraries (e.g., system libraries 1234, API libraries 1236, and other libraries 1238), and frameworks/middleware 1218 to create user interfaces to interact with users of the system. Alternatively, or additionally, in some systems, interactions with a user may occur through a presentation layer, such as presentation layer 1244. In these systems, the application/module “logic” can be separated from the aspects of the application/module that interact with a user.

Some software architectures utilize virtual machines. In the example of FIG. 12, this is illustrated by virtual machine 1248. A virtual machine creates a software environment where applications/modules can execute as if they were executing on a hardware computing device. A virtual machine is hosted by a host operating system (operating system 1214) and typically, although not always, has a virtual machine monitor 1246, which manages the operation of the virtual machine 1248 as well as the interface with the host operating system (i.e., operating system 1214). A software architecture executes within the virtual machine 1248 such as an operating system 1250, libraries 1252, frameworks/middleware 1254, applications 1256 and/or presentation layer 1258. These layers of software architecture executing within the virtual machine 1248 can be the same as corresponding layers previously described or may be different.

### Modules, Components and Logic

A computer system may include logic, components, modules, mechanisms, or any suitable combination thereof. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. One or more computer systems (e.g., a standalone, client, or server computer system) or one or more hardware processors may be configured by software (e.g., an application or application portion) as a hardware-implemented module that operates to perform certain operations as described herein.

A hardware-implemented module may be implemented mechanically or electronically. For example, a hardware-implemented module may comprise dedicated circuitry or logic that is permanently configured (e.g., as a special-purpose processor, such as a field programmable gate array [FPGA] or an application-specific integrated circuit [ASIC]) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Hardware-implemented modules may be temporarily configured (e.g., programmed), and each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). Multiple hardware-implemented modules are configured or instantiated at different times. Communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. The processor or processors may be located in a single location (e.g., within a home environment, an office environment, or a server farm), or the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

The systems and methods described herein may be implemented using digital electronic circuitry, computer hardware, firmware, software, a computer program product (e.g., a computer program tangibly embodied in an information carrier, e.g., in a machine-readable medium for execution by, or to control the operation of, data processing apparatus, e.g., a programmable processor, a computer, or multiple computers), or any suitable combination thereof.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites (e.g., cloud computing) and interconnected by a communication network. In cloud computing, the server-side functionality may be distributed across multiple computers connected by a network. Load balancers are used to distribute work between the multiple computers. Thus, a cloud computing environment performing a method is a system comprising the multiple processors of the multiple computers tasked with performing the operations of the method.

Operations may be performed by one or more programmable processors executing a computer program to perform functions by operating on input data and generating output. Method operations can also be performed by, and apparatus of systems may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. A programmable computing system may be deployed using hardware architecture, software architecture, or both. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out example hardware (e.g., machine) and software architectures that may be deployed.

### Example Machine Architecture and Machine-Readable Medium

FIG. 13 shows a block diagram of a machine in the example form of a computer system 1300 within which instructions 1324 may be executed for causing the machine to perform any one or more of the methodologies discussed herein. The machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1300 includes a processor 1302 (e.g., a central processing unit (CPU), a graphics processing unit (GPU), or both), a main memory 1304, and a static memory 1306, which communicate with each other via a bus 1308. The computer system 1300 may further include a video display unit 1310 (e.g., a liquid crystal display (LCD) or a cathode ray tube (CRT)). The computer system 1300 also includes an alphanumeric input device 1312 (e.g., a keyboard or a touch-sensitive display screen), a user interface (UI) navigation (or cursor control) device 1314 (e.g., a mouse), a storage unit 1316, a signal generation device 1318 (e.g., a speaker), and a network interface device 1320.

### Machine-Readable Medium

The storage unit 1316 includes a machine-readable medium 1322 on which is stored one or more sets of data structures and instructions 1324 (e.g., software) embodying or utilized by any one or more of the methodologies or functions described herein. The instructions 1324 may also reside, completely or at least partially, within the main memory 1304 and/or within the processor 1302 during execution thereof by the computer system 1300, with the main memory 1304 and the processor 1302 also constituting a machine-readable medium 1322.

While the machine-readable medium 1322 is shown in FIG. 13 to be a single medium, the term “machine-readable medium” may include a single medium or multiple media (e.g., a centralized or distributed database, and/or associated caches and servers) that store the one or more instructions 1324 or data structures. The term “machine-readable medium” shall also be taken to include any tangible medium that is capable of storing, encoding, or carrying instructions 1324 for execution by the machine and that cause the machine to perform any one or more of the methodologies of the present disclosure, or that is capable of storing, encoding, or carrying data structures utilized by or associated with the instructions 1324. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 1324 may further be transmitted or received over a communications network 1326 using a transmission medium. The instructions 1324 may be transmitted using the network interface device 1320 and any one of a number of well-known transfer protocols (e.g., hypertext transport protocol [HTTP]). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 1324 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A system comprising:
a memory that stores instructions; and
one or more processors coupled to the memory and configured to execute the instructions to perform operations comprising:
providing a support ticket for a software application to a trained machine learning model as input;
receiving, from the trained machine learning model, a probability that the support ticket is addressed by modification of source code of the software application;
based on the probability and a predetermined threshold, selecting a support group to send the support ticket to; and
sending the support ticket to the selected support group.

2. The system of claim 1, wherein the operations further comprise:
generating the trained machine learning model by providing a training set comprising a set of historical support tickets, each of the historical support tickets labeled with a class of a set of classes comprising a minority class and a majority class, more of the historical support tickets having majority class labels than minority class labels.

3. The system of claim 2, wherein the class that labels each historical support ticket identifies a support group that resolved the historical support ticket.

4. The system of claim 2, wherein the operations further comprise:
validating the trained machine learning model by determining a proportion of correct classifications of the historical support tickets classified by the trained machine learning model as the minority class out of a total number of classifications of the historical support tickets classified by the trained machine learning model as the minority class.

5. The system of claim 2, wherein the operations further comprise:
validating the trained machine learning model by determining a proportion of correct classifications of the historical support tickets classified by the trained machine learning model as the minority class out of a total number of the historical support tickets labeled as the minority class.

6. The system of claim 5, wherein the minority class comprises no more than 10% of the support tickets and the majority class comprises at least 70% of the support tickets.

7. The system of claim 6, wherein the generating of the trained machine learning model comprises applying a balanced log loss function that penalizes misclassifications of the minority class more than misclassifications of the majority class.

8. The system of claim 1, wherein:
the trained machine learning model is a second machine learning model;
the probability that the support ticket is addressed by modification of source code of the software application is a second probability;
the predetermined threshold is a second predetermined threshold;
the operations further comprise:
providing the support ticket for a software application to a first trained machine learning model as input; and
receiving, from the first trained machine learning model, a first probability that the support ticket is addressed by modification of source code of the software application; and
the providing of the support ticket for the software application to the second machine learning model is based on the first probability and a first predetermined threshold.

9. The system of claim 8, wherein the first machine learning model is a simpler model than the second machine learning model.

10. A non-transitory computer-readable medium that stores instructions that, when executed by one or more processors, cause the one or more processors to perform operations comprising:
providing a support ticket for a software application to a trained machine learning model as input;
receiving, from the trained machine learning model, a probability that the support ticket is addressed by modification of source code of the software application;
based on the probability and a predetermined threshold, selecting a support group to send the support ticket to; and
sending the support ticket to the selected support group.

11. The non-transitory computer-readable medium of claim 10, wherein the operations further comprise:
generating the trained machine learning model by providing a training set comprising a set of historical support tickets, each of the historical support tickets labeled with a class of a set of classes comprising a minority class and a majority class, more of the historical support tickets having majority class labels than minority class labels.

12. The non-transitory computer-readable medium of claim 11, wherein the class that labels each historical support ticket identifies a support group that resolved the historical support ticket.

13. The non-transitory computer-readable medium of claim 11, wherein the operations further comprise:
validating the trained machine learning model by determining a proportion of correct classifications of the historical support tickets classified by the trained machine learning model as the minority class out of a total number of classifications of the historical support tickets classified by the trained machine learning model as the minority class.

14. The non-transitory computer-readable medium of claim 11, wherein the operations further comprise:
validating the trained machine learning model by determining a proportion of correct classifications of the historical support tickets classified by the trained machine learning model as the minority class out of a total number of the historical support tickets labeled as the minority class.

15. The non-transitory computer-readable medium of claim 14, wherein the minority class comprises no more than 10% of the support tickets and the majority class comprises at least 70% of the support tickets.

16. The non-transitory computer-readable medium of claim 15, wherein the generating of the trained machine learning model comprises applying a balanced log loss function that penalizes misclassifications of the minority class more than misclassifications of the majority class.

17. A method comprising:
providing, by one or more processors, a support ticket for a software application to a trained machine learning model as input;
receiving, from the trained machine learning model, a probability that the support ticket is addressed by modification of source code of the software application;
based on the probability and a predetermined threshold, selecting a support group to send the support ticket to; and
sending, by the one or more processors, the support ticket to the selected support group.

18. The method of claim 17, further comprising:
generating the trained machine learning model by providing a training set comprising a set of historical support tickets, each of the historical support tickets labeled with a class of a set of classes comprising a minority class and a majority class, more of the historical support tickets having majority class labels than minority class labels.

19. The method of claim 18, wherein the class that labels each historical support ticket identifies a support group that resolved the historical support ticket.

20. The method of claim 18, further comprising:
validating the trained machine learning model by determining a proportion of correct classifications of the historical support tickets classified by the trained machine learning model as the minority class out of a total number of classifications of the historical support tickets classified by the trained machine learning model as the minority class.
